(19) United States
(12) Patent Application Publication
(10) Pub. No.: US 2014/0071337 A1
(43) Pub. Date: Mar. 13, 2014

(54) ELECTRONIC DEVICE WITH CAMERA MODULE

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: JU-PING DUAN, Shenzhen (CN); MING-FU LUO, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/858,201

(22) Filed: Apr. 8, 2013

(30) Foreign Application Priority Data
Sep. 10, 2012 (CN) 201210331519.9

(51) Int. Cl. H04N 5/225

(52) U.S. Cl. CPC H04N 5/2256
USPC 348/370

(57) ABSTRACT

An electronic device includes a housing, a shield cover, a camera module, and a plurality of light emitting members. A connecting hole is defined in the housing. The transparent protective cover is positioned in the connecting hole. The shield cover is positioned in the housing facing the connecting hole. The camera module is positioned and is received in the shield cover. The plurality of light emitting members is positioned and is received in the shield cover around the camera module.

### BACKGROUND

1. Technical Field

The present disclosure generally relates to electronic devices, and particularly to an electronic device with a camera module.

2. Description of the Related Art

Electronic devices, such as tablet computers, mobile phones, usually include a camera module for taking or capturing photos, video chatting and camera shooting. But imaging quality of the captured photos or videos is not good if the camera module of electronic device works in an environment under weak light. A flash lamp is usually positioned adjacent to the camera module in the electronic device to improve illumination brightness. However, the light from the flash lamp is illuminated immediately and scattered in all directions to negatively affect the image quality, such as producing shining areas that can be found in the captured images.

Therefore, there is room for improvement within the art.

### BRIEF DESCRIPTION OF THE DRAWING

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 shows an assembled, isometric view of an electronic device of an embodiment.

FIG. 2 is a partial and isometric view of the electronic device of FIG. 1.

FIG. 3 is a partial and exploded view of the electronic device of FIG. 2.

FIG. 4 is similar to FIG. 3, but viewed from another aspect.

FIG. 5 is similar to FIG. 2, but viewed from another aspect.

FIG. 6 is a cross sectional view of the electronic device of FIG. 2, taken along line VI-VI.

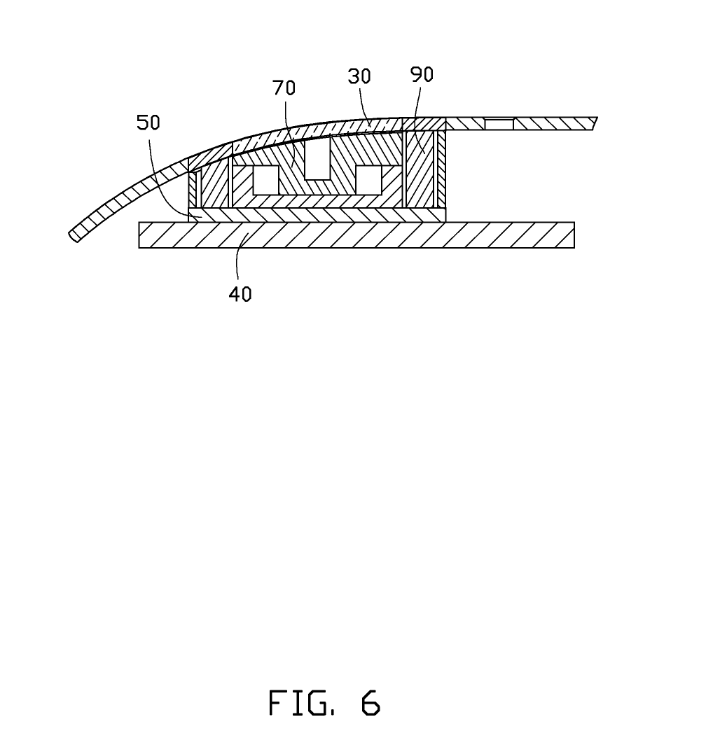

### DETAILED DESCRIPTION

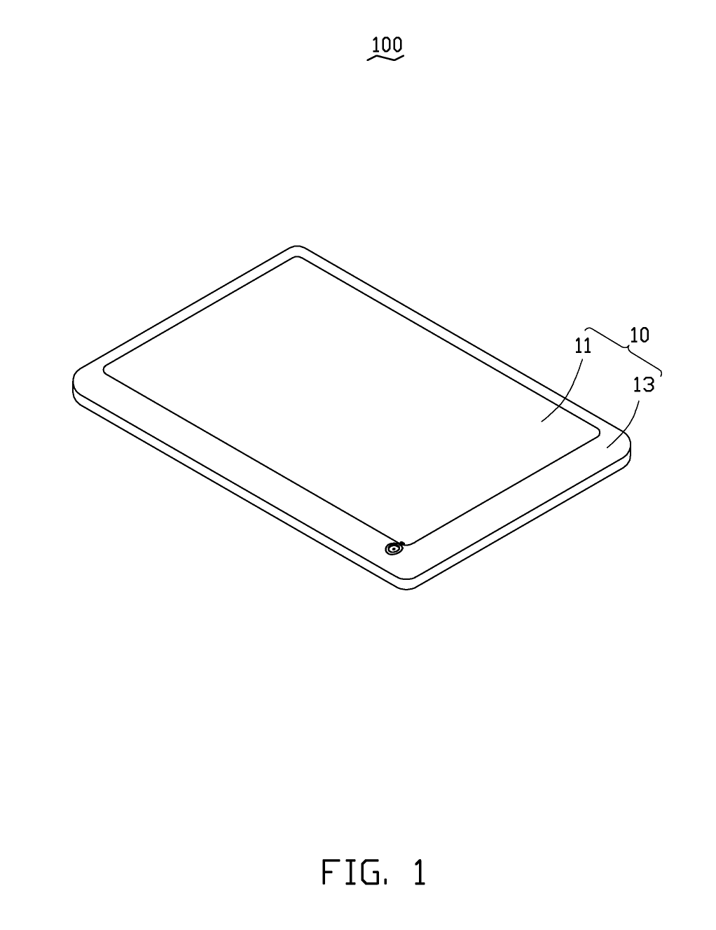

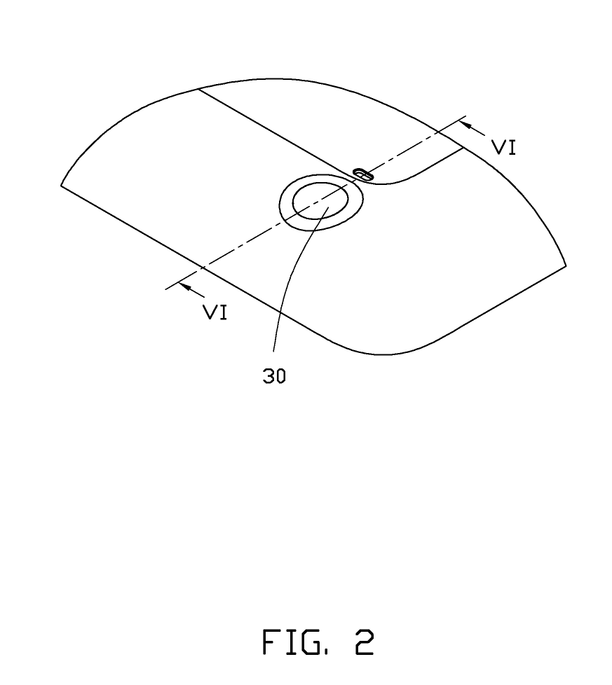

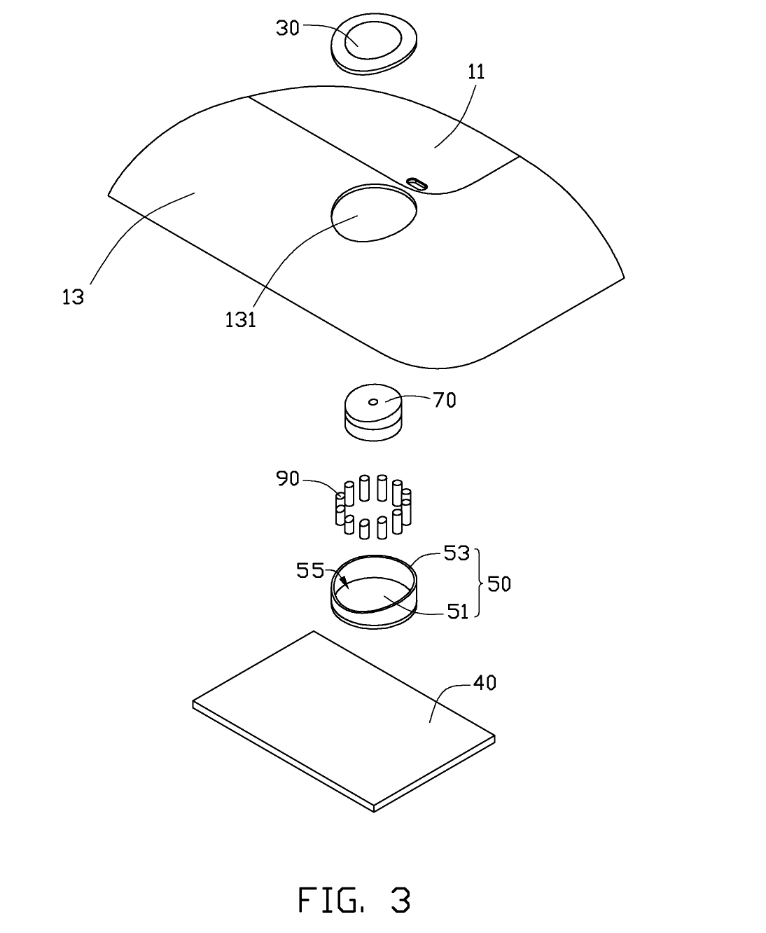

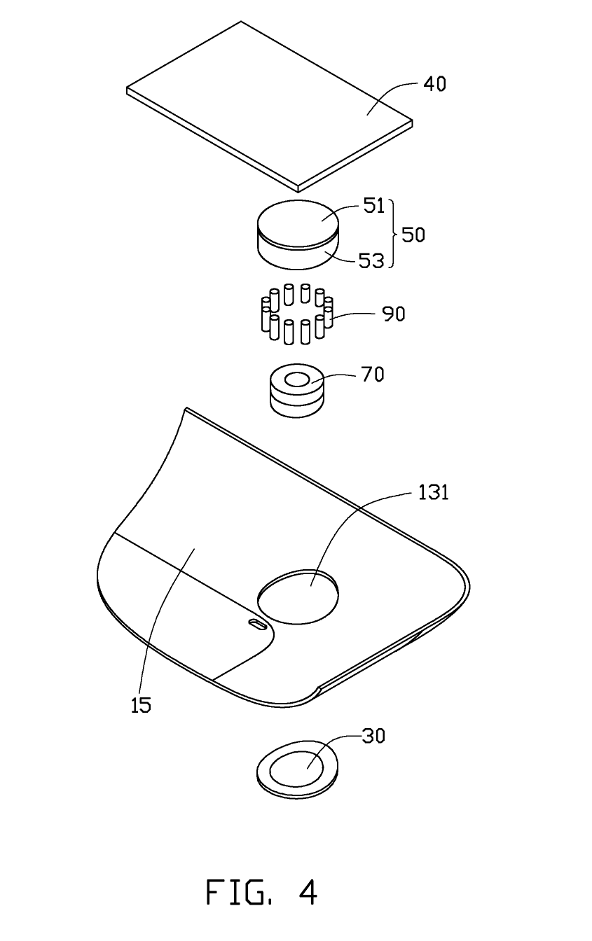

FIG. 1 is a disclosure of an electronic device 100. In the present embodiment, a tablet computer is illustrated. In other embodiments, the electronic device 100 can be mobile phones, media players or other electronic devices employing a camera module having a lens module. In the embodiment, only the lens module of the camera module is being shown, and the rest of the camera module is omitted herein for brevity. FIG. 1-FIG. 4 show that the electronic device 100 includes a housing 10, a protective cover 30, a mounting board 40, a shield cover 50, a lens module 70, and a plurality of light emitting members 90. The protective cover 30 is mounted on the housing 10 for protecting the lens module 70. The mounting board 40 is positioned in the housing 10 adjacent to the protective cover 30. The shield cover 50 is mounted on the mounting board 40 facing the protective cover 30. The lens module 70 is positioned and received in the shield cover 50. The plurality of the light emitting members 90 is positioned around the lens module 70 and received in the shield cover 50. For the sake of simplicity and brevity, other functional modules or components are not described herein.

The substantially rectangular housing 10 includes a bottom wall 11 and a sidewall 13 extending in a curved fashion from edges of the bottom wall 11. A connecting hole 131 is defined in the bottom wall 11 adjacent to the sidewall 13. The bottom wall 11 and the sidewall 13 cooperatively form a receiving space 15. The connecting hole 131 communicates with the receiving space 15.

The protective cover 30 is made of transparent material. The protective cover 30 is mounted and received in the connecting hole 131 to enclose the connecting hole 131. A shape and size of the protective cover 30 fits and matches the connecting hole 131. The mounting board 40 is received in the receiving space 15 adjacent to the connecting hole 131 and parallel to the bottom wall 11.

The shield cover 50 is made of material which can stop light from escaping and scattering, such as rubber, polystyrene, polyurethane, metal, or other materials. The shield cover 50 is mounted on the mounting board 40 facing the protective cover 30. The substantially cylindrical-shaped shield cover 50 includes a bottom 51 and a peripheral wall 53 extending substantially perpendicularly from an edge of the bottom 51. In the illustrated embodiment, a surface of the bottom 51 is adhered to the mounting board 40 via adhesive. The shield cover 50 has an opening 55 away from the bottom 51. Profiles of an edge of the opening 55 fits and matches a flange of the connecting hole 131. The edge of the opening 55 connects with the flange of the connecting hole 131.

The lens module 70 is substantially a cylinder, positioned and received in the shield cover 50. One end of the lens module 70 is mounted on the bottom 51 of the shield cover 50.

The plurality of light emitting members 90 is mounted and received in the shielding sleeve 50 around the lens module 70. Each light emitting member 90 is substantially a cylinder. Heights of the lights emitting members 90 are different. The light emitting members 90 are arranged on the bottom 51 having a range of heights being consistent with variations in the height of the peripheral wall 53. The light emitting members 90 are cold light sources to provide continuous illumination for the lens module 70. In the illustrated embodiment, the light emitting members 90 are LED cold light sources.

The electronic device 100 further includes a control module (not shown) electrically connected to the plurality of light emitting members 90 for controlling time and brightness of the light emitting members 90.

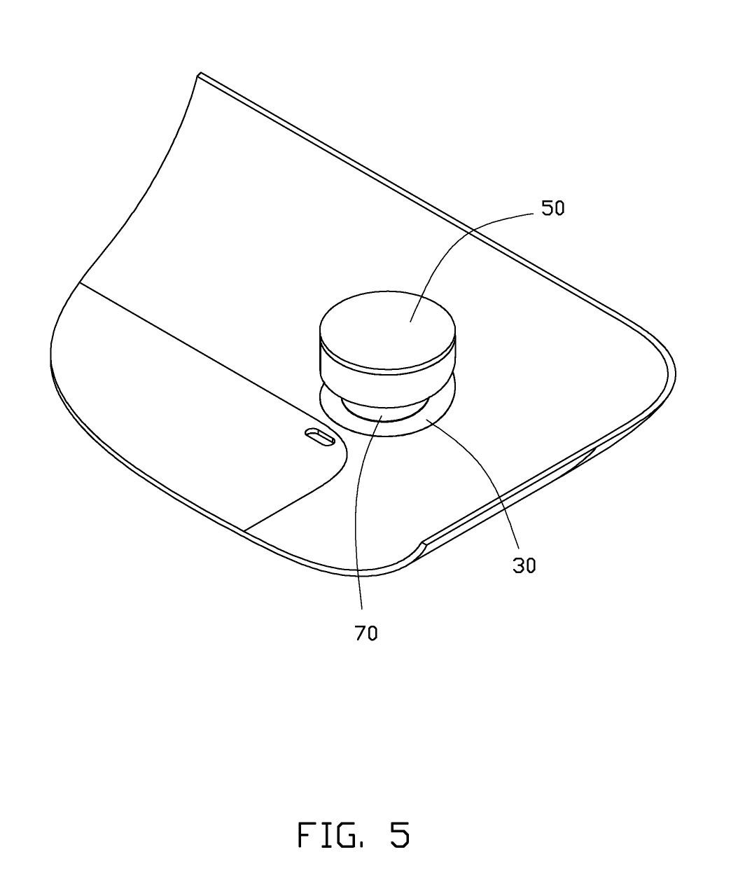

FIG. 5 shows that in assembly, the protective cover 30 is positioned in the connecting hole 131. The plurality of light emitting members 90 and the lens module 70 are mounted on the bottom 51 of the shield cover 50 and received in the shield cover 50. The mounting board 40 is assembled with the shield cover 50. Next, the shield cover 50 is put into the housing 10 together with the mounting board 40. The plurality of light emitting members 90 is electrically connected with the control module.

When the lens module 70 is working under an operating environment having weak lighting or poor illumination, the plurality of light emitting members 90 is turned on and emits light for illumination. The control module controls the brightness and duration of lighting of the light emitting members 90 for taking or capturing high quality images.

The light emitting members 90 and the lens module 70 are positioned and received in the shield cover 50. The shield cover 50 is made of material able to stop light emitted by the light emitting members 90 from escaping and scattering to improve the image quality. In addition, the light emitting members 90 are positioned around the lens module 70. Light emitted by the light emitting members 90 is distributed more evenly because of being in a configuration of forming a light circle around the lens module 70. Further, the light emitting members 90 are cold light sources, and lower amounts of heat is generated to protect the lens module 70. Compared with traditional flash lamp, lighting provided by the light emitting members 90 is not flashed immediately but is being illuminated continuously and gently when emitted by the light emitting members 90 to protect users eyes.

The number of light emitting members 90 can be one, two, three or others. When the number of the light emitting members 90 is only one, a structure of the light emitting member 90 can be in a sleeve shape or a ring shape. Then the light emitting member 90 is directly put into the shield cover 50, and the lens module 70 is positioned in a substantial middle portion of the light emitting member 90.

The mounting board 40 can be omitted, the shield cover 50 can be directly mounted in the housing 10.

The shield cover 50 can be a hollow structure and directly assembled with the protective cover 30.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. An electronic device comprising:
a housing defining a connecting hole;
a transparent protective cover positioned in the connecting hole;
a shield cover positioned in the housing facing the connecting hole,
a camera module positioned and received in the shield cover; and
a plurality of light emitting members positioned and received in the shield cover around the camera module.

2. The electronic device of claim 1, wherein the electronic device further comprises a mounting board positioned in the housing, and the shield cover is mounted on the mounting board.

3. The electronic device of claim 1, wherein the housing comprising a bottom wall and a sidewall, the shield cover comprises a bottom and a peripheral wall extending from an edge of the bottom of the shield cover, the connecting hole is defined in the bottom wall of the housing, and the plurality of light emitting members and the camera module are positioned on the bottom and received in the shield cover.

4. The electronic device of claim 3, wherein the plurality of light emitting members is arranged on the bottom of the shield cover having a range of heights varying with the height of the peripheral wall.

5. The electronic device of claim 1, wherein the plurality of light emitting members is cold light sources.

6. An electronic device comprising:
a housing defining a connecting hole;
a transparent protective cover positioned in the connecting hole;
a shield cover positioned in the housing facing the connecting hole,
a camera module positioned and received in the shield cover; and
a light emitting member positioned and received in the shield cover positioned adjacent to the camera module.

7. The electronic device of claim 6, wherein the electronic device further comprises a mounting board positioned in the housing, and the shield cover is mounted on the mounting board.

8. The electronic device of claim 6, wherein the housing comprising a bottom wall and a sidewall, the shield cover comprises a bottom and a peripheral wall extending from an edge of the bottom, the connecting hole is defined in the bottom wall of the housing, and the plurality of light emitting members and the camera module are positioned on the bottom and received in the shield cover.

9. The electronic device of claim 1, wherein the light emitting member is a cold light source.
